(19) United States
(12) Patent Application Publication
(10) Pub. No.: US 2013/0166221 A1
(43) Pub. Date: Jun. 27, 2013

(54) METHOD AND SYSTEM FOR SEQUENCE CORRELATION

(71) Applicants: Stuart John INGLIS, Hamilton (NZ); Leonard Eric TRIGG, Ngahinapouri (NZ); Richard Henry LITTIN, San Francisco, CA (US); David William WARE, Hamilton (NZ); Sean Alistair IRVINE, Hamilton (NZ); John Gerald CLEARY, Hamilton (NZ); Graham Charles GAYLARD, San Francisco, CA (US); Mehul Kamlesh RATHOD, Auckland (NZ)

(72) Inventors: Stuart John INGLIS, Hamilton (NZ); Leonard Eric TRIGG, Ngahinapouri (NZ); Richard Henry LITTIN, San Francisco, CA (US); David William WARE, Hamilton (NZ); Sean Alistair IRVINE, Hamilton (NZ); John Gerald CLEARY, Hamilton (NZ); Graham Charles GAYLARD, San Francisco, CA (US); Mehul Kamlesh RATHOD, Auckland (NZ)

(21) Appl. No.: 13/681,215

(22) Filed: Nov. 19, 2012

Related U.S. Application Data
(63) Continuation of application No. PCT/NZ2011/000081, filed on May 20, 2011.

(30) Foreign Application Priority Data
May 20, 2010 (NZ) 585505
May 21, 2010 (NZ) 585532
Jun. 8, 2010 (NZ) 585984

(51) Int. Cl. G06F 19/22

(52) U.S. Cl. CPC G06F 19/22
USPC 702/20

(57) ABSTRACT

A method and system are provided for evaluating the correlation between sequences by entering segments of one sequence in a database and comparing segments of the other sequence with the index values to find correlated segments. The correlated segments are analysed to determine whether the spacing is within a defined range indicating that a correlation threshold has been met. A processing methodology may be employed whereby a coarse potential alignment algorithm is first applied to determine potential alignment at a plurality of potential alignment positions, which are filtered based on alignment scores, and a fine alignment algorithm is then applied.

### CROSS REFERENCE TO RELATED APPLICATIONS

This is a continuation of PCT Application No. PCT/NZ2011/000081, with an international filing date of May 20, 2011, which claims priority to New Zealand Application No. NZ585505, filed May 20, 2010, New Zealand Application No. NZ585532, filed May 21, 2010, and New Zealand Application No. NZ585594, filed Jun. 8, 2010. PCT Application No. PCT/NZ2011/000081, filed May 20, 2011, is incorporated herein by reference in its entirety.

### FIELD OF THE INVENTION

The present invention relates to methods and systems for evaluating the correlation of sequences. More particularly, although not exclusively, the invention relates to methods of evaluating the correlation between sample and reference genomic sequences based on the correlation of spaced apart sequence segments.

### BACKGROUND TO THE INVENTION

In nature there are numerous patterns that can be interpreted as sequences of discrete units. In biology, the sequence of nucleotides in DNA or RNA, and the sequences of amino acids in proteins are of particular interest. In DNA, sequences consist of discrete units which may take on one of the values A, C, G, T, while in RNA sequences, the values are A, C, G, and U. Proteins represent a ore complicated sequence, as individual units may be one of 21 or more amino acids—in general 22 amino acids.

In biosciences much effort has been devoted to correlating sample sequences to reference sequences (such as a reference genome). DNA and RNA elements may take on one of the following values: A, C, G, T, U. The length of a sequence may vary from relatively small (for example thousands) to large (for example billions) and so evaluating sequence correlation may be computationally demanding.

Sequencing machines are used to produce a machine readable encoding of such biological sequences. These machines use a variety of techniques to interpret the molecular information, and may introduce errors into the data in both systematic and random ways. Errors can usually be categorised into substitution errors, where the real code is substituted with an incorrect code (for example A swapping with G in DNA), or so called indel errors (insertion/deletion), where a random unit is inserted (for example AGT becoming AGCT in DNA) or deleted (for example AGTA becoming ATA).

DNA sequencing machines generate segments of sample sequences called “reads” (a long string of DNA), where each read is a small length of coding a section of a genome sequence sample molecule, for example a 3 billion long DNA collection of chromosomes may have reads of only 100 units in length. Due to the method of generating the reads, the original position of each read against the original sequence is unknown, and so aligning techniques must be used to determine the original location of the reads. Typically alignment will need to take into account that the direction of the reads is also unknown.

Reads may be contiguous, as with sequencers produced by Illumina Inc. or be non-continuous or overlapping, as with sequencers produced by Complete Genomics Inc. and Pacific Biosciences Inc. It is desirable for evaluation algorithms to be able to process any type of read.

Due to the nature of the sequencing machine and/or the chemistry involved the reads often are generated with a known length gap (or range) in the read. These are referred to as “paired end” reads. A specific example would be a 100 nucleotide paired end read having a “left arm” of 100 nucleotides long, a gap of approximately 200 to 350 nucleotides long, followed by a “right arm” of 100 nucleotides long. What defines paired end read is a length of DNA, a gap and another length of DNA. This may be generalized to K lengths of DNA and M gaps.

To place paired end data onto a reference sequence, typically a reference genome, (otherwise known as read mapping, or sequence mapping) is to find some number of matches for the left arm, and then find some number of matches for the right arm. For each read pair the locations are then compared to see if they are within the valid range (e.g. if the left arm hits at position x1 and the right arm hits at position y1 then if |x1-y1| is in the range of 200 to 350 then the mating criteria is met). If a pair of arms is within the range they are considered a “mated pair”.

Mated pairs provide more contextual information than non-mated (or unmated) reads when mapped against a genome. Statistically the correlation of two mated reads to a reference genome gives a far higher confidence of correlation than for two unmated reads.

When searching for potential alignment sites there can be differences between the read and the correct segment and so typically a search will uncover multiple places in the genome with high levels of fit that are not identical. Search systems are typically configured to produce alignment locations corresponding to possible positions in the reference where the reads correspond to. Often, there are multiple reads that need to be aligned with the reference requiring high levels of computation using fine alignment algorithms.

It is an object of the present invention to provide a method and system for evaluating the correlation of sequences that is computationally faster than conventional methods or which at least provides the public with a useful choice.

### SUMMARY OF THE INVENTION

According to a first aspect there is provided a method of evaluating the correlation between a set of segments of a sample sequence and one or more reference sequences including the steps of:
a. indexing the segments of the sample sequence to generate indexes in a database;
b. comparing segments of the one or more reference sequences with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met.

There is also provided a method of evaluating the correlation between a set of segments of a sample sequence and one or more reference sequences including the steps of:
a. indexing segments of the reference sequence to generate indexes in a database;
b. comparing segments of the sample sequence with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met.

According to a further aspect there is provided a method for evaluating one or more sequences with respect to a reference sequence, including the steps of:
a. for each sequence, obtaining at least one correlated position within the reference sequence using the above method;
b. for each correlated position using one or more alignment algorithms to compare the sample sequence with the reference sequence at the correlated position.

According to a further aspect there is provided a method for evaluating one or more sequences with a reference sequence, including the steps of:
a. for each sequence, attempting to obtain at least one correlated position within the reference sequence using the method above;
b. if at least one correlated position is found, then for each correlated position using one or more alignment algorithms to compare the sample sequence to the reference sequence at the correlated position to obtain a measure of correlation.

There is further provided a sequence analyser comprising:
a. an index generator for generating index values based on sample sequence segments;
b. a database for storing index values and associated correlation information;
c. a processing engine for streaming reference sequences through the database and recording correlation information in the database; and
d. an evaluation engine for evaluating the correlation information to identify potentially correlated sequences.

According to another aspect there is provided a computer implemented method for evaluating correlation of one or more sample sequence with one or more reference sequence, including the steps of:
a. applying a coarse potential alignment algorithm to determine potential alignment at a plurality of potential alignment positions;
b. producing an alignment score at each potential alignment position;
c. filtering potentially aligned results based on alignment scores; and
d. applying a fine alignment algorithm.

In one embodiment alignment scores falling outside a threshold range are excluded. In another embodiment only a selected number N of potential alignment positions having the best alignment scores are retained for further processing by the fine alignment algorithm. In another embodiment a sample sequence is discarded if the number of potential alignment positions exceeds a threshold value.

According to a further aspect there is provided a method for improving a sequence alignment process, including analysing results from one or more sequence alignment processes, and modifying one or more parameters for the sequence alignment process based on the analysis.

According to a further aspect there is provided an identification system for identifying genetic material including a sequencing unit, a data processing unit, and an output unit, wherein the sequencing unit is configured to read genetic sequences and output a data sequence representing the genetic sequence to the data processing unit, which is configured to analyse a data sequence with respect to a database of known genetic sequences and provide an output from the output unit when sequence matching is of a prescribed level.

According to a further aspect there is provided a sequencing machine configured for monitoring reads as they are obtained, comparing the reads to reference sequences, and indicating contamination if the comparison is within a prescribed level.

According to a further aspect there is provided a method for comparing a first sequence to a second sequence, wherein the first sequence and the second sequence include a sequence of values, including the steps of:
a. creating a first set of binary number sequences from the sequence of values of the first sequence, wherein corresponding bits of each first binary number sequence combine to create a binary representation of each corresponding value of the first sequence;
b. creating a second set of second binary number sequences from the sequence of values of the second sequence, wherein corresponding bits of each second binary number sequence combine to create a binary representation of each corresponding value in the second sequence;
c. performing bitwise operations between each corresponding first binary number sequence and second binary number sequence, such that a comparison is made between the first sequence and the second sequence; and
d. creating a score based on the comparison between the first sequence and the second sequence.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 illustrates the insertion of a block into a genomic sequence to create paired ends;

FIG. 2 illustrates the formation of an index from overlapping reads;

FIG. 3 illustrates the application of a sliding window to a reference sequence to stream a reference sequence through a sequence analysing system;

FIG. 4 shows a sequence analyser according to one embodiment;

FIG. 5 shows a parallel processing system according to one embodiment;

FIG. 6 shows a flow diagram for a lower bound filter;

FIG. 7 shows a flow diagram for a top end filter;

FIG. 8 shows a flow diagram for a progressive lower bound filter;

FIG. 9 shows a block diagram of a continuous monitoring system according to one embodiment; and

FIG. 10 shows a block diagram of a continuous monitoring system according to another embodiment.

### DETAILED DESCRIPTION

The method will now be described by way of example with reference to a specific embodiment, though it is noted that this is not a limiting case. In bioinformatics, genetic information from a sample is compared to a known genome in order to correctly identify the location in the genome from which the sample is derived. The samples are typically read by an automated reader known as a sequencer, which produces a list of bases corresponding to the sample known as a read. For DNA, the bases are labelled A, C, G, T, though these may be converted to numbers for use by computers (i.e. 0, 1, 2, 3).

The invention will now be described by way of example only, with reference to examples based on the analysis of nucleotide sequences in the form of genomic sequences of DNA or RNA. Such sequences may be represented in a variety of ways and the following description relates to any such representation or translations of a sequence (e.g. colour space representations).

A common class of sequencers are known to produce paired-end reads, in which a small segment of the beginning and end of the sample are read to produce a “left-arm” read and “right-arm” read respectively. A property of these sequencers is that the distance between the left-arm and right-arm is known to be within a range of values and this is known as the correlation range. There are other situations where “structural variation” occurs and the search constraints will depend upon the nature of the structural variant “break points”.

FIG. 1 shows an example in which structural variation is caused by the insertion of an inserted sequence 3 into an original sequence between left hand 1 and right hand 2 pairs. The number of bases has been minimised for illustrative purposes.

The first step is to build an index of read segments in a database. The read segments may be entire reads or parts of reads. This may be done in accordance with the method described in the applicant's international patent application Patent Application No. PCT/NZ2009/000245. The index may be constructed by applying one or more sliding mask over each sample sequence to generate index values. The mask may be a simple window of fixed length (typical between 14 to 25 bases in length and preferably about 18) or the masks may include insertions, deletions or substitutions. For each index entry the read and the position of the mask is recorded. As described in PCT/NZ2009/000245 the sample sequence and/or the reference sequence may be indexed.

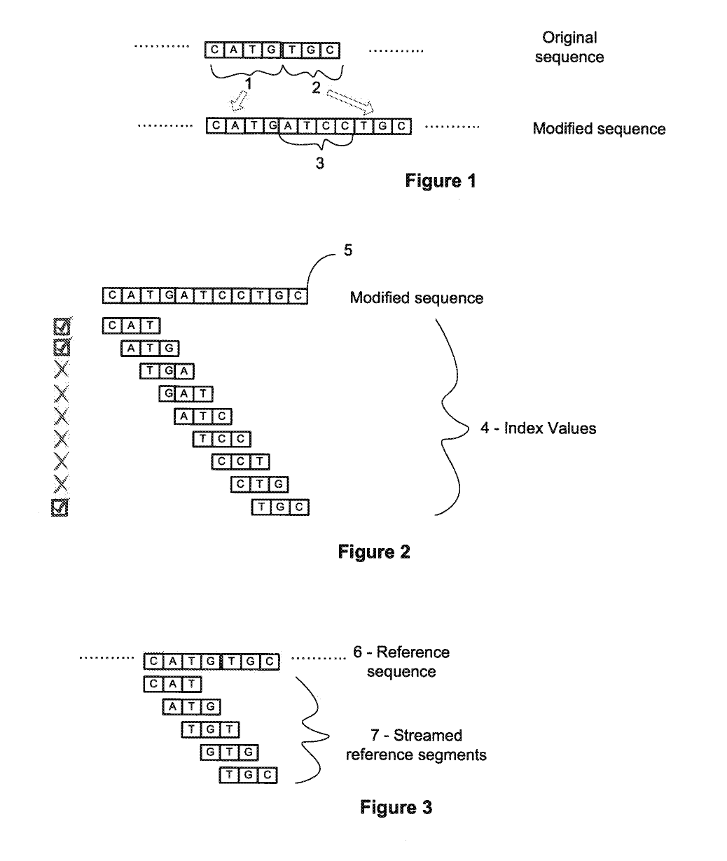

FIG. 2 illustrates the generation of index values 4 from modified sequence 5 in the form of overlapping reads in this case (although these may be contiguous or incomplete reads also depending upon whether the sequencer produces continuous reads as with Illumina Inc., overlapping reads as with Complete Genomics Inc. or otherwise.)

In the case of genetic sequences, reading the sequence in one direction produces a reverse complement result when compared to reading the sequence in the other direction. Therefore, the index values may include reverse complement entries as well as the sequenced entries. In this case, an additional constraint on the pairs may be that one of the entries is the reverse complement of the corresponding genome segment.

The next step is to stream the one or more reference sequence through the database. A sliding window may be applied and the segments 7 of the reference sequence 6 as shown in FIG. 3 may be compared with the index values and where a segment of the reference sequence matches an index value the reads and the read positions for the associated index value may be noted (“hits”). The window is preferably of fixed length, sized correctly to enable the correct processing of gaps between the left and right arms.

One or many reference sequences may be streamed through the database sequentially or in parallel where a parallel computing platform is employed. Hits from the same read may then be evaluated to determine their spacing. If two read segments have a spacing within a prescribed range (positive “coarse evaluation”) then the read may be further processed using an alignment algorithm (“detailed evaluation”) to more accurately evaluate the level of correlation between the read and the reference sequence. The prescribed range may depend upon the position in the reference sequence, the sequencing machine employed, the chemistry of the sequences, be user defined or based on historical information. The range may be a bounded range (e.g. between 200 to 300) or unbounded (e.g. greater than 300 or outside the range of 200 to 300 etc.)

There may be more than two reads which are correlated. In this case, the distance between pairs of reads may be the correlation condition. For example, in the case of three reads A, B, and C, it is known that the distance between A and B is in the range of 100-150 elements, and the distance between B and C is in the range of 50-200 elements. Each read A, B, and C is therefore correlated to each of the other reads, though the correlation between A and C is implied as being 150-350 plus the length of B. The quality of correlation may be scored based on the range (e.g. a range greater than 300 may have a higher score than a range between 200 and 300 if large separation is of interest). More complex pattern matching criteria may be employed where multiple spaced sequence segments are involved.

The read may be aligned with the reference sequence according to a position at which a read segment matched the reference sequence and the correlation of the entire read to the reference genome may be determined at that position using an alignment algorithm to provide an alignment score. This evaluation may be performed with the read aligned with the reference sequence at each location where a segment of the genome matched an index value for the read. The matching criteria may require complete correlation but more typically some threshold will be applied based on rules, statistical thresholds etc. and may include the direction in which the arms of the paired read are read (e.g. the left arm must be read in the forwards direction, while the right arm must be read in the reverse complement direction). If the alignment score is above a threshold value (which may be set by a user), then the read and position of the read may be recorded. The alignment score may be based on “local alignment” where only a portion of a read is compared to a reference sequence to exclude the effects of outer portions that may be corrupt. The alignment score may also take into account particular attributes of the segments concerned (e.g. it may be particularly important or not important that particular parts match).

It will be appreciated that the above technique may be applied to match patterns of three or more spaced apart sample sequence segments or other patterns as required. It will also be appreciated that the matching condition for both the initial coarse match of “hits” and the detailed correlation of a read aligned with a reference sequence may not require absolute correlation and the matching criteria may be based on rules, statistical thresholds etc.

The hits that do not meet the mating criteria can then be processed as “unmated reads” (i.e. if the mated reads do not produce a result exceeding an acceptance threshold then single read segment hits may be used to align reads with the reference sequence to determine correlation.

For repeated regions (regions of similarity that repeat again and again throughout the genome), this invention limits the problems associated with reads that map to potentially hundreds or more of locations as the search is naturally constrained to be within the mating criteria. By conducting a quick coarse evaluation of mated pairs as described above prior to applying detailed analysis using alignment algorithms processing can be performed much faster.

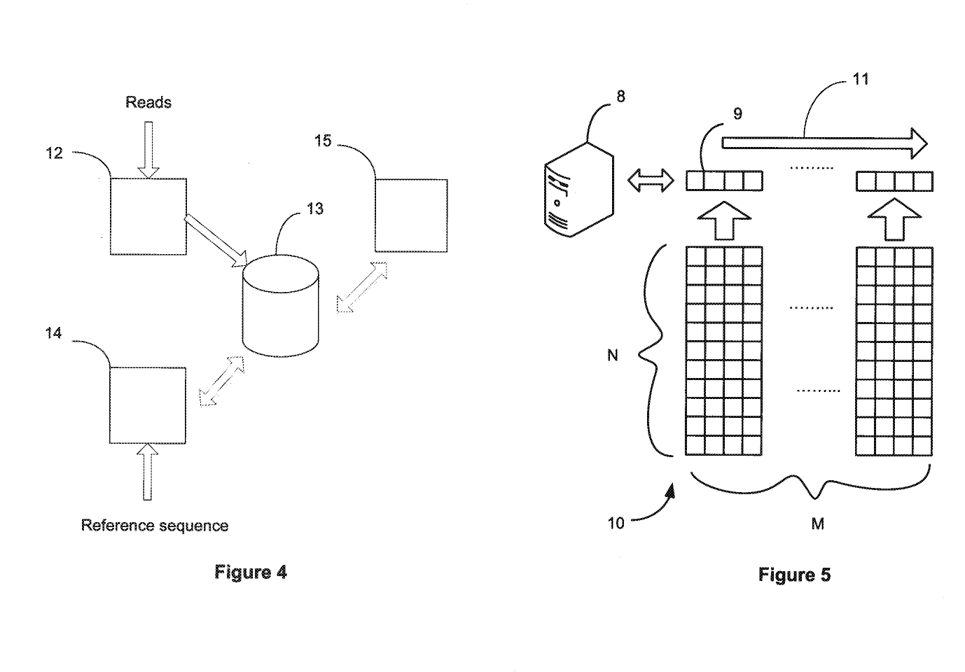

FIG. 4 shows a sequence analyser for performing the method according to one embodiment. The sequence analyser includes an index generator 12 for generating index values based on sample sequence segments; a database 13 for storing index values and associated correlation information; a processing engine 14 for streaming reference sequences through the index values of database 13 and recording correlation information in the database 13; and an evaluation engine 15 for evaluating the correlation information to identify potentially correlated sequences.

The index generator 12 may apply one or more mask to each sample sequence to generate index values representing segments of the sample sequence (in some cases the segments are entire sample sequences) and variants (i.e. additions, deletions or substitutions of sequence elements) of those segments. The evaluation engine 15 may run one or more alignment algorithm to identify sequences meeting alignment criteria.

The processing engine 14 may employ parallel processors configured to process multiple reference sequence segments through the processing engine in parallel (see below). The evaluation engine 15 may also employ parallel processors configured to run multiple alignment algorithms in parallel. The parallel processors may be local or distributed and the alignment algorithms may be associated with processors based on their processing characteristics.

It will be appreciated from the applicant's international patent application Patent Application No. PCT/NZ2009/000245 that the index may be based upon either the reads or the reference sequence. One system for processing paired reads is the parallel processing system shown in FIG. 5 in which the reference sequence may form the index (using the sliding window approach illustrated in FIG. 3) and reads 10 may be streamed through parallel processors 9 under the control of processor 8. The parallel processors may typically be graphics processors and in this example 1024 graphics processors are employed. Where M=1024 then 1024 reads per cycle are streamed into parallel processors 9. In this embodiment processor 8 may step the reference sequence index values through processors 9 such that once reads 10 have all been streamed through a set of index values the index values are shifted as indicated by arrow 11 and the reads streamed through the next set of index values.

It will be appreciated that reads (segments of a sample sequence) may also be used to form the index stored in processor 8. In this case segments of the reference sequence 10 may be streamed through in blocks of N and compared by each parallel processor against all the indexes. By monitoring the hits in successive blocks of N over a range of interest (say 6 blocks of 50 for a separation of 300) hits falling within a desired spacing may be identified and further analysed.

A significant advantage with this approach is that where it is known that paired ends fall within a certain spacing (depending on the window size for processing) then where two hits occur within any cycle it is known that the hits are within at least this spacing. Such hits may be further investigated. The number of processors employed and the manner they are utilised may also be controlled to achieve this result. Thus an initial level of assessment is achieved simply by the architecture employed.

Now a multi-stage alignment methodology will be described. In the present system, a coarse alignment may be performed between reads and the reference sequence(s), which typically locates a large number of possible alignment positions on the reference. Since a read is a part of a real sample, in theory it only truly aligns to one position in the reference, however due to errors in the sequencing of the read and real variation between samples and the reference, it is unusual that only one alignment position is found.

After the coarse alignment, a filtering step may be performed which may incorporate one or more filters to reduce the number of possible alignment positions quickly with minimal risk or removing a real alignment position. The coarse alignment may be a paired end alignment as described above or some other alignment.

After the filtering step, a final accurate alignment technique may be applied to the selected reads which attempts to accurately align the read with regards to the reference.

Coarse Alignment

Typically a coarse alignment technique will compare multiple reads to a reference sequence (template) and produce a set of potential alignment positions for each read. Often, each read is hashed and indexed, where it is converted into a number representing a portion of the read and stored in an index. The index is then compared at each point in the template using a similar hashing technique, and matches are recorded as a potential ‘hit’. The index may include multiple entries per read, covering substitution and indel modification of the reads and also the reverse compliment direction of the reads (see the method described in international patent application Patent Application No. PCT/NZ2009/000245).

Improvements can be made to the alignment technique by identifying reads which occur many times in the reference. During coarse alignment, if the number of potential alignment positions for a particular read increases beyond a specified limit, the read may be removed from the index such that it is no-longer incorporated into the alignment procedure, and a record made that the read has been excluded due to being ambiguous due to too high a number of hits. In one embodiment, the specified limit is set before beginning the coarse alignment, and may be set by a user or by an automated process.

Another improvement that can be made to the coarse alignment technique is to remove from the index values that are known to correspond to a large number of positions in the reference (heavily repeated regions). This information may be collated over time, so that as more coarse alignments are made on the same reference, the set of index values that should be excluded can be refined.

In one embodiment, where there is more than one index value per read (for example, covering substitutions, indels, and reversals), it may be important to ensure that all the index values corresponding to the read are not removed. The minimum number of index values per read may be set before the coarse alignment. Typically, at least one index value per read should be retained to ensure that all reads may potentially be assessed in a full alignment process.

The advantage of removing index values corresponding to heavily repeated regions is that processing time during both coarse alignment, and later procedures, can be greatly reduced without significantly reducing the alignment quality.

Filtering

The result of performing a coarse alignment on a read is a set of potential alignment positions. This set can be very large, and therefore a full alignment is a time consuming task. A filtering step may therefore be used to reduce the overall set of potential alignment positions by discarding potential alignment positions that do not meet the threshold of a filter. There are several different filters possible. In general, the requirement for a filter is that it is fast and has a low false negative rate and a corresponding high true positive rate.

In the following discussion, “fast” implies that using the filter before a full alignment step will decrease the overall processing time. A low false negative rate means that the filter has a minimal chance of rejecting or removing a potential alignment position which corresponds to a real alignment position. A high true positive rate means that the filter has a maximal chance of keeping potential alignment positions which do correspond to a real alignment position.

The following discussion centres on a selection of possible filters, however it is noted that any filter that meets the above qualification is suitable.

Lower Bound Filter

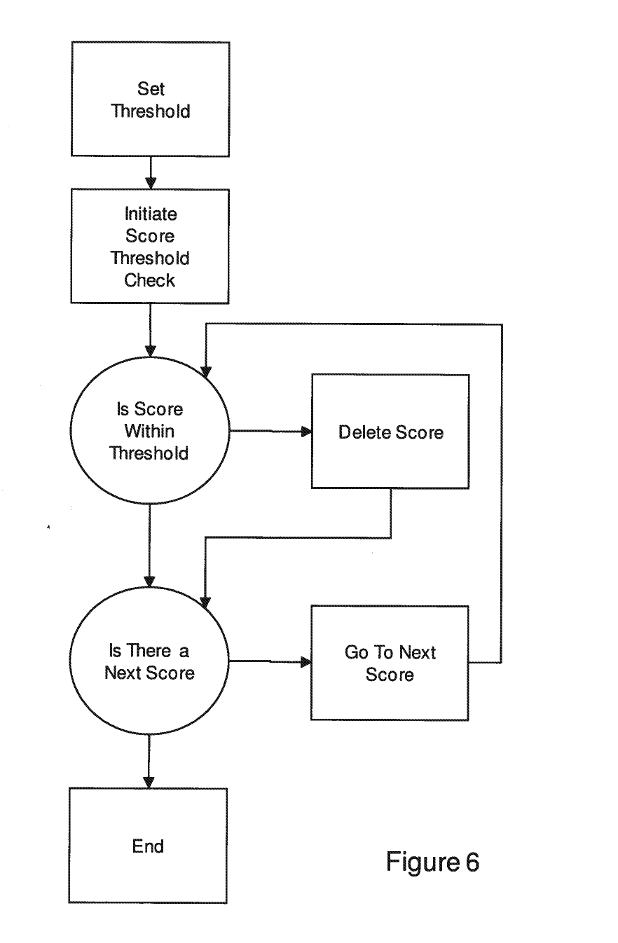

The lower bound filter uses an exact algorithm to determine how well a read will match against the reference sequence at the potential alignment position as illustrated in FIG. 6. A score is produced indicating how well the read matches the reference sequence at the potential alignment position. In one embodiment, the score is a relative value where 0% indicates a perfect match (0% of the read is different to the reference at the potential alignment position) and 100% indicates a complete mismatch. Typically, due to random errors and real differences between the sample and the reference, the score will be between 0% and 100%.

The lower bound score is compared to the lower bound limit, which is simply a number or a percentage. Potential alignment positions with scores above the lower bound limit are removed from the set of potential alignment positions, while scores below this value are ignored.

In one embodiment, the lower bound limit is set by a user before applying the filter. However, other options include lower bound limits which are based on feedback from previous alignment procedures as to which limit is preferable. The limit may also be selected based on a preferred processing time, comparative performance measure with a reference algorithm (e.g. BLAST) or other user prescribed parameter.

Top-N

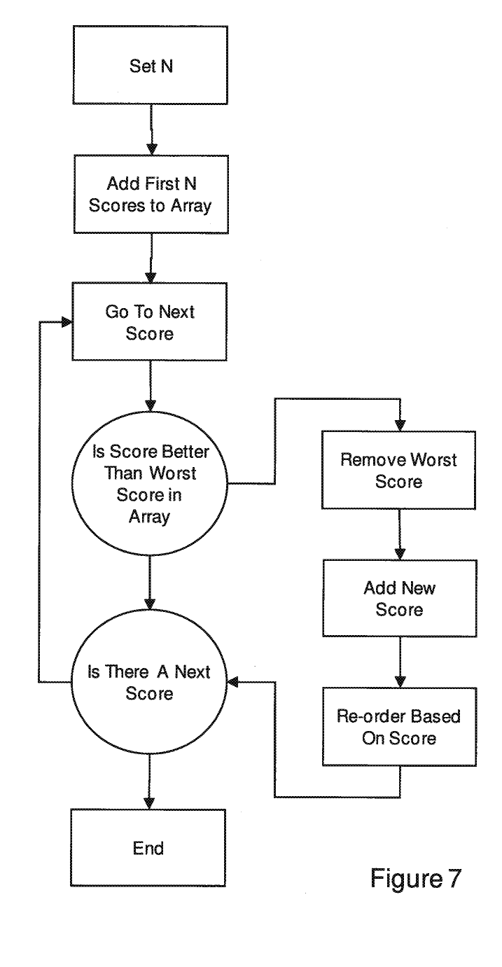

Top-N refers to a filtering process in which there are only a maximum of ‘N’ potential alignment positions remaining after applying the filter as illustrated in FIG. 7. Here, N is any positive integer, however for Top-N to be practical N should be significantly lower than the number of potential alignment positions.

In one embodiment, Top-N is implemented by systematically scoring each potential alignment position in a similar way to the lower bound method. For the first N potential alignment positions, each position and score is recorded in an ordered array, such that the highest scoring potential alignment position is stored at the beginning of the array and the lowest scoring potential alignment position is stored at the end of the array.

For each subsequent potential alignment position, the score of the current potential alignment position is compared to the lowest score in the array. If the score is higher than the lowest score in the array, then the lowest score in the array is removed from the array, and the current potential alignment position and score is added to the array and the array re-ordered based on the score values. In this way, the array maintains records of the top N scoring potential alignment positions and the corresponding alignment scores. Although this is described as “top-N” it will be appreciated that the highest scoring potential alignment may have the lowest value and so here the alignment positions with the lowest N scores may be retained.

After the filter has been applied, the set of potential alignment positions is the N potential alignment positions remaining in the array.

In one embodiment the value for ‘N’ may be user selected. Other options include an N value based on prior knowledge about the read (i.e. how may places the read maps to, how useful the read is for biological analysis etc), feedback from previous alignment procedures as to the most useful value for ‘N’ that provides the best trade-off between alignment running time and accuracy.

In one embodiment, the Top-N procedure is applied only to so-called “non-mated” reads, which are reads without another corresponding read which has a known correlation. As mated reads have a higher confidence rating Top-N may be used to filer only the non-mated reads. In another embodiment, the Top-N procedure is instead applied only to so called “mated” reads, which are reads with one or more correlated reads. In a situation where processing is limited only the mated reads may be selected for further processing. It is also envisioned that complicated criteria as set by a user or an automated process can be used to select which reads have the Top-N filter applied to them.

Progressive Lower Bound

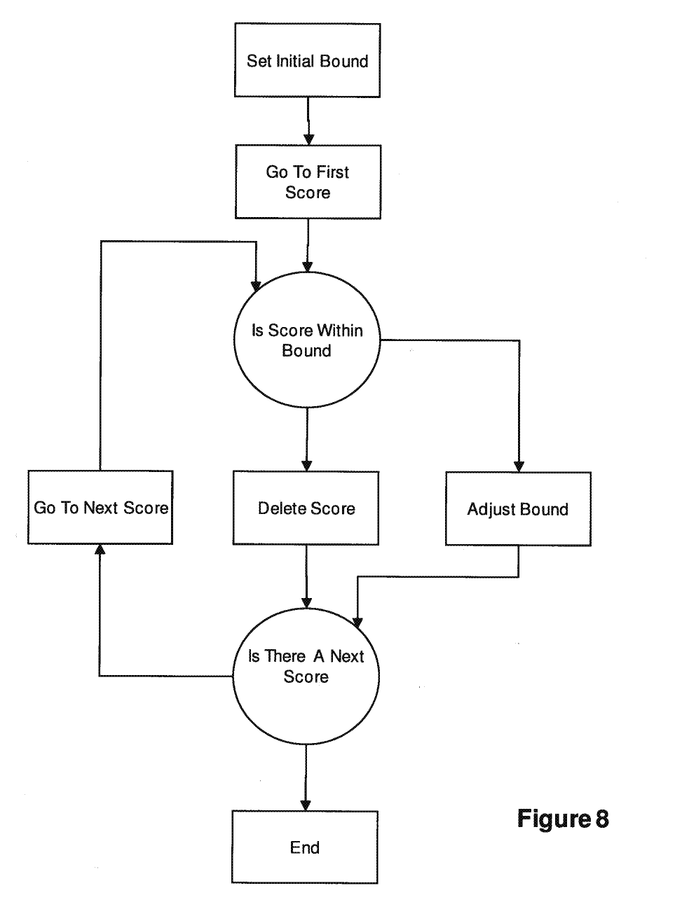

The progressive lower bound filter is similar to the lower bound filter described herein; however the lower bound is adjustable during application of the filter as illustrated in FIG. 8.

In one embodiment, the lower bound is adjusted such that it is equal to the best scoring potential alignment position so far analysed. In this way, the filter will reject potential alignment positions that are not as good as the best so far discovered.

In another embodiment, the lower bound is adjusted such that there is some ‘head-room’. This can be achieved by adjusting the bound such that scores within a percentage of the best score so far are also included. For example, if the head-room is 10%, and the best score so far is 30%, then scores of 33% or better are not removed by the filter.

In one embodiment, previously unfiltered scores that are worse than the current best score are removed in a post processing step.

Continuous Monitoring System

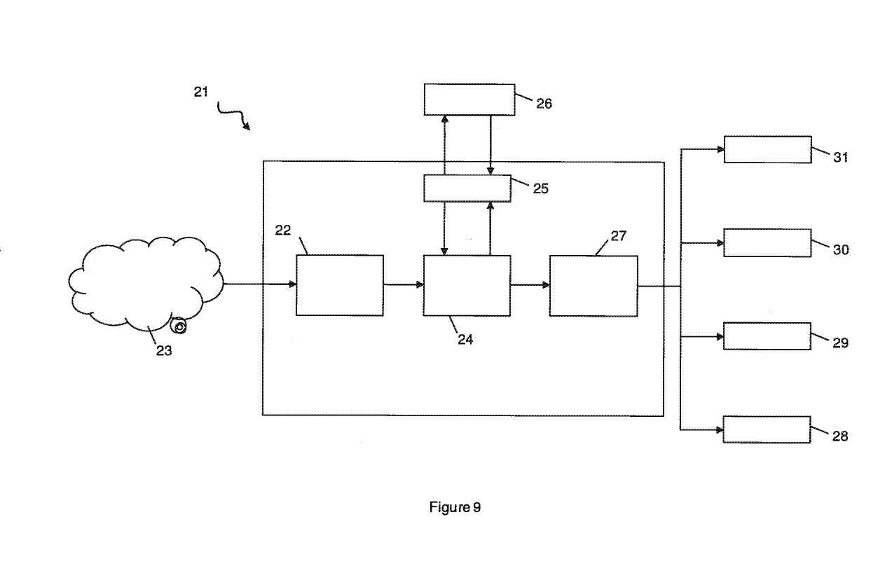

A continuous monitoring system incorporates an alignment procedure into a device for sampling and processing biological samples. An example application for this is as an in-the-field sampling system or as an environmental monitoring system as shown in FIG. 9.

The continuous monitoring system 21 may include a sampling device 22, which may automatically take samples of an environment 23, or may receive samples via a user or an external automated system. The sampling device is configured to read the biological information and produce a computer readable representation of the data to data processing unit 24.

In one embodiment, the sampling device is configured to read genetic material from the sample, and produce read sequences representing portions of the genetic material. The genetic material may include one or more of DNA, RNA, proteins, or other genetic information able to be represented as a sequence.

The read sequences may be compared on the fly to a database of sample sequences in memory 25, which may be updated via network 26 from a central database.

If the genetic samples contain genetic material of sufficient similarity to a sample sequence, for example a sequence representing a particular bacteria, then the sequencing unit may produce a number of hits between the index and the read sequences. If the number of hits is above a predetermined threshold, then the sequencing unit may report an alert, which may optionally include the specific organism or genetic material detected, and/or a measure of the accuracy of the result.

An alert unit 27 may be configured to alert a user or record the alert in a memory 30. For example, when the system is used as an environmental monitoring system, it may alert via a network 28 a monitoring station to the presence of the organism or genetic material. In another example, an in-the-field sampling system may report the presence of one or more organisms or genetic material in the sample via a user interface 29. In one embodiment, the alert is signalled as an alarm, for example a visual or audible alarm 31, to warn one or more users of the threat detected.

It is important that errors in organism or genetic material identification are minimised. In one embodiment, this is in part achieved by checking whether a read hits against multiple different types of organism or genetic material. For example, if a dangerous organism is detected from a read, but also a non dangerous organism, and there is a higher chance that the mapping is to the non dangerous organism, then this information must either be incorporated into the overall results.

The index may be updated via a remote updating facility or by a user. Typically, the index is compiled from a variety of known references, in such a way that the one index may be copied and used by a large number of systems. This allows the index building process, which can be both memory and time consuming, to be performed once for a large number of machines.

Sequencer Contamination Detection

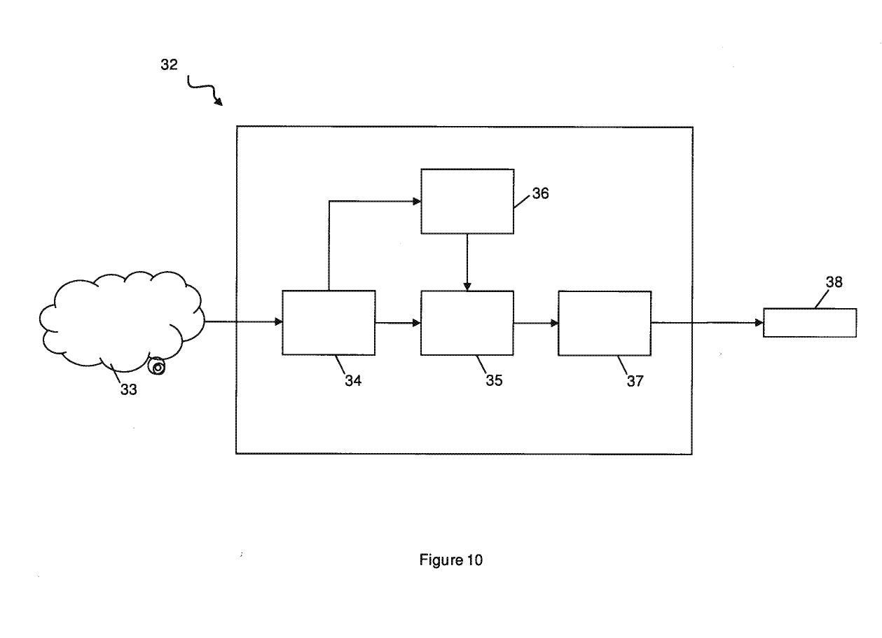

In another embodiment shown in FIG. 10 a continuous monitoring system 32 may detect impurities or contaminants present at a sampling unit, such as a sequencer 34. For example, it may be that human genetic material is present at the sampling unit, or that airborne contaminants are present. If these contamination levels are low, then the overall processing time is relatively unaffected by the presence of the impurities. However, if the contamination level is high, then much of the sampling and sequencing time will be being devoted to data that is not relevant for the task at hand.

In one embodiment, the continuous monitoring system 36 may include an index containing information relating to known or expected contaminants (for example human DNA). Reads from sequencing unit 34 are monitored by detection unit 36 during operation of the sequencing unit 34 and data processing unit 35. If a predetermined percentage of reads are being mapped to the expected contaminants (for example, reads mapping to information on human DNA) then the contamination detection unit 36 may send a signal to data processing unit 35, which may be configured to alert a user that contamination has been detected via output unit 37 and user interface 38. The user may then proceed to reduce or remove the impurities and/or the cause of the impurities, to the data processing unit 35 may also shut down operation of the sequencer and/or a linked process (for example, shutting down water supply to a population) until the issue has been dealt with by a user or organisation.

Feedback Methods

A sequencing system includes a number of parameters which affect the outcome of a sequencing process, and also the sequencing time. For example, the choice of ‘N’ from the Top-N filter described herein can affect the overall processing time, the number of false hits, and other properties of the sequencing. The present system allows for parameters to be adjusted based on previous sequencing results.

In one embodiment, variance calling is a processing step that occurs after the alignment stage of the sequencing process. Variance calling takes the aligned reads and inspects situations where reads overlap. If there are a number of overlapping reads, which are not in total agreement with either themselves or the reference, then it is usually more likely that a majority of agreeing reads are correct, even if different from the reference. However, different weighting algorithms may also be applied.

Genetic material may naturally be different among samples, so the reference and the present sample may really be different, as indicated by the overlapping reads. However, random errors caused by the sampling machines may also be present. In general, a set of overlapping reads will not share a random error, and so outliers may be rejected. Incorrectly mapped reads will also stand out from an overlapping collection of reads based on entries which do not correlate with other reads from the overlapping set, and these incorrectly mapped reads may be removed from the mapped results.

Analysis of variance calling results may enable optimisation of alignment and variance calling algorithms.

In another embodiment, simulations may be used to investigate how changing mapping parameters can improve mapping results. This may be achieved by obtaining a sequence of known genetic material (for example, a known reference sequence), and make a relatively small number of changes at random throughout the sequence, while recording the position of these changes. This may simulate genetic diversity in a population. The next step is to introduce errors in the form of random noise (simulating random sequencing errors) and machine specific errors (for example, a machine may be known to not record accurately long strings of similar units—i.e. a DNA string of the form AAAAAAAAA). These errors are not recorded as they do not represent ‘real’ deviations from the reference sequence.

The simulation sequence is then mapped using the same techniques as used on real samples. The goal of the mapping is to minimise incorrectly aligned reads, minimise the effect of errors while maximising the identification of “real” deviations from the reference. The mapping parameters that provide a superior alignment may be fed back into the system for future mapping.

The present invention thus provides alignment methods that significantly reduce processing time and apparatus capable of performing real time biological monitoring. There is also provided a sequencing machine including on the fly monitoring of samples to detect contaminants and avoid lengthy processing of contaminated samples.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

### Exemplary Embodiments

1. A method of evaluating the correlation between a set of segments of a sample sequence and one or more reference sequences including the steps of:
a. indexing the segments of the sample sequence to generate indexes in a database;
b. comparing segments of the one or more reference sequences with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met.

2. A method as claimed in claim 1 wherein indexing the sample sequences includes generating an index value for each unique segment of the sample sequences and associating an identifier of the sample sequence and position of the segment with each index value.

3. A method as claimed in claim 2 wherein each segment of the sample sequence is obtained by passing a mask over the sample sequence.

4. A method as claimed in claim 3 wherein the mask is of a fixed length.

5. A method as claimed in claim 3 wherein multiple masks are used.

6. A method as claimed in claim 5 wherein the masks include indels.

7. A method as claimed in claim 5 wherein the masks include substitutions.

8. A method as claimed in any one or the preceding claims wherein the one or more reference sequences are sequentially streamed through the database.

9. A method as claimed in any one or the preceding claims wherein multiple reference sequences are streamed through the database in parallel.

10. A method as claimed in any one or the preceding claims wherein segments of multiple reference sequences are compared with the database indexes.

11. A method as claimed in any one or the preceding claims wherein the sequences are nucleotide sequences.

12. A method as claimed in claim 11 wherein the sequences are proteins.

13. A method as claimed in claim 11 wherein the sequences are amino acids.

14. A method as claimed in claim 11 wherein the sequences are genomic sequences.

15. A method as claimed in claim 14 wherein the sequences are DNA sequences.

16. A method as claimed in claim 14 wherein the sequences are RNA sequences.

17. A method as claimed in any one or the preceding claims wherein each correlated segment within a set of correlated segments is unique.

18. A method as claimed in any one of the previous claims wherein the defined range is dependent upon the position of the pair of correlated segments concerned.

19. A method as claimed in any one of the previous claims wherein the defined range is dependent upon the chemistry of the sequences concerned.

20. A method as claimed in any one of the previous claims wherein the defined range is dependent upon characteristics of equipment used to obtain the sample sequences.

21. A method as claimed in any one of the preceding claims wherein the range is a bounded range.

22. A method as claimed in any one of claims 1 to 20 wherein the range is an unbounded range.

23. A method as claimed in any one of the preceding claims wherein the correlation threshold is based on three or more segments of a sample sequence satisfying two or more range conditions between segments.

24. A method as claimed in any one of the previous claims wherein the correlated segments within a set of correlated segments are ordered.

25. A method as claimed in claim 24 wherein the spacing is between neighbouring pairs of correlated segments within the set of correlated segments.

26. A method as claimed in any one of the previous claims wherein the correlated segments correspond to segments of the reference sequence.

27. A method as claimed in any one of the previous claims wherein the sample sequences are obtained using a DNA sequencer.

28. A method as claimed in any one of the preceding claims wherein segments of the sample sequences are considered to be correlated with a reference sequence when there is a defined level of similarity between the correlated segments of a sample sequence and a reference sequence.

29. A method as claimed in claim 28 wherein the similarity is based on a maximum number of substitutions, insertions, and/or deletions to achieve similarity between a read and a segment of the reference sequence.

30. A method as claimed in claim 29 wherein segments of the sample sequences are considered to be correlated with a reference sequence when there is local or global correlation between a defined portion of the sample sequences and a reference sequence.

31. A method as claimed in any one of the preceding claims wherein each index value is a numerical representation of a segment of a sequence.

32. A method as claimed in claim 31 wherein the index values are translations of sample sequence values.

33. A method as claimed in any one the preceding claims wherein the length of each segment is set at least in part by a user.

34. A method as claimed in any one claims 1 to 32 wherein the length of each segment is set at least in part based on historical data.

35. A method as claimed in any one of claims 1 to 32 wherein the length of each segment is selected based on a desired accuracy and/or processing time.

36. A method as claimed in any one of claims 1 to 32 wherein the length of each segment is within the range of 14 to 22.

37. A method as claimed in claim 36 wherein the length of each segment is 18.

38. A method as claimed in any one of claims 1 to 37 wherein each segment of the reference sequence is the same size as the size of the segments of the each sample sequence used to build the index.

39. A method of evaluating the correlation between a set of segments of a sample sequence and one or more reference sequences including the steps of:
a. indexing segments of the reference sequences to generate indexes in a database;
b. comparing segments of the sample sequence with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met.

40. A method for evaluating one or more sequences with respect to a reference sequence, including the steps of:
a. for each sequence, obtaining at least one correlated position within the reference sequence using the method of any one of claims 1 to 39;
b. for each correlated position using one or more alignment algorithms to compare the sample sequence with the reference sequence at the correlated position.

41. A method as claimed in claim 40 wherein in step b the one or more alignment algorithms determine correlation with a reference sequence when there is local correlation between a defined portion of a sample sequence and a reference sequence.

42. A method for evaluating one or more sequences with a reference sequence, including the steps of:
a. for each sequence, attempting to obtain at least one correlated position within the reference sequence using the method of any one of claims 1 to 41;
b. if at least one correlated position is found, then for each correlated position using one or more alignment algorithms to compare the sample sequence to the reference sequence at the correlated position to obtain a measure of correlation.

43. A method as claimed in claim 42 including the further step of performing further sequence analysis on any unaligned sequence to attempt to align it with the reference sequence.

44. A method as claimed in claim 43 wherein further sequence analysis is selected from one or more of known sequence analysis techniques.

45. processing means for evaluating sample sequences operating according to the method of any one of the preceding claims.

46. A sequence analyser comprising:
a. an index generator for generating index values based on sample sequence segments;
b. a database for storing index values and associated correlation information;
c. a processing engine for streaming one or more reference sequences through the database and recording correlation information in the database; and
d. an evaluation engine for evaluating the correlation information to identify potentially correlated segments.

47. A sequence analyser as claimed in claim 46 wherein the evaluation engine runs one or more alignment algorithm to identify sequences meeting alignment criteria.

48. A sequence analyser as claimed in claim 46 or claim 47 wherein the index generator applies one or more mask to each sample sequence to generate index values representing segments of the sample sequence and variants of those segments.

49. A sequence analyser as claimed in claim 46 or claim 47 wherein the index generator applies one or more mask to each sample sequence to generate index values representing entire sample sequences and variants of those sequences.

50. A sequence analyser as claimed in claim 48 or claim 49 wherein the variants have additions, deletions or substitutions of sequence elements.

51. A sequence analyser as claimed in any one of claims 46 to 50 wherein the processing engine includes parallel processors configured to process multiple reference sequence segments through the processing engine in parallel.

52. A sequence analyser as claimed in any one of claims 46 to 51 wherein the evaluation engine employs alignment algorithms to evaluate the correlation information.

53. A sequence analyser as claimed in any one of claims 46 to 52 including parallel processors configured to run multiple alignment algorithms in parallel

54. A sequence analyser as claimed in 53 wherein the parallel processors are distributed.

55. A sequence analyser as claimed in claim 53 or claim 54 wherein alignment algorithms are associated with processors based on their processing characteristics.

56. A sequencing system including a sequencer and a sequence analyser as claimed in any one of claims 46 to 55.

57. A sequence analyser comprising:
a. an index generator for generating index values based on one or more reference sequences;
b. a database for storing index values and associated correlation information;
c. a processing engine for streaming one or more sample sequence segments through the database and recording correlation information in the database; and
d. an evaluation engine for evaluating the correlation information to identify potentially correlated segments.

58. A sequence analyser as claimed in claim 57 wherein the processing engine includes parallel processors configured to sequentially receive index values and stream the sample sequence segments through the parallel processors.

59. A sequence analyser as claimed in claim 58 wherein the parallel processors are graphics processors.

60. A sequence analyser as claimed in any one of claims 57 to 59 wherein the processing engine identifies segments as potentially correlated if multiple segments of a sample sequence are identified as matching index values during the same parallel processing step.

61. A computer implemented method for evaluating correlation of one or more sample sequence with one or more reference sequence, including the steps of:
a. applying a coarse potential alignment algorithm to determine potential alignment at a plurality of potential alignment positions;
b. producing an alignment score at each potential alignment position;
c. filtering potentially aligned results based on alignment scores; and
d. applying a fine alignment algorithm.

62. A method as claimed in claim 61 wherein alignment scores falling outside a threshold range are excluded.

63. A method as claimed in claim 62 wherein scores above a threshold value are excluded.

64. A method as claimed in claim 62 wherein scores below a threshold value are excluded.

65. A method as claimed in any one of claims 62 to 65 wherein the threshold is set by a user.

66. A method as claimed in any one of claims 62 to 65 wherein the threshold is set based on sequence attributes.

67. A method as claimed in any one of claims 62 to 65 wherein the threshold is set based on apparatus attributes.

68. A method as claimed in any one of claims 62 to 65 wherein the threshold is set based on processing time.

69. A method as claimed in any one of claims 62 to 65 wherein the threshold is set based on required alignment quality.

70. A method as claimed in any one of claims 62 to 65 wherein the threshold is set based on feedback as to the quality of alignment for given threshold values.

71. A method as claimed in any one of claims 62 to 70 wherein a threshold value is continuously set as the best score determined to date.

72. A method as claimed in claim 71 wherein scores within a set percentage of the threshold value are retained.

73. A method as claimed in any one of the preceding claims wherein only a selected number N of potential alignment positions having the best alignment scores are retained for further processing by the fine alignment algorithm.

74. A method as claimed in claim 73 wherein the potential alignment positions and their associated scores are placed in a buffer that is ordered based on alignment scores.

75. A method as claimed in claim 73 or claim 74 wherein N is a constant for all reads.

76. A method as claimed in claim 73 or claim 74 wherein N is variable.

77. A method as claimed in claim 75 or claim 14 wherein N is user set.

78. A method as claimed in claim 75 or claim 76 wherein N is set based on sequence attributes.

79. A method as claimed in claim 75 or claim 76 wherein N is set based on apparatus attributes.

80. A method as claimed in claim 75 or claim 76 wherein N is set based on processing time.

81. A method as claimed in claim 75 or claim 76 wherein N is set based on required alignment quality.

82. A method as claimed in claim 75 or claim 76 wherein the threshold is set based on feedback as to the quality of alignment for given values of N.

83. A method as claimed in any one of claims 73 to 82 wherein the threshold is set based on feedback as to the quality of alignment for given values of N.

84. A method as claimed in any one of claims 73 to 82 when applied only to unmated reads.

85. A method as claimed in any one of claims 73 to 82 when applied only to mated reads.

86. A method as claimed in any one of claims 73 to 85 wherein the number N is determine based on multiple parameters.

87. A method as claimed in any one of claims 60 to 86 wherein a sample sequence is discarded if the number of potential alignment positions exceeds a threshold value.

88. A method as claimed in any one of claims 60 to 86 wherein sample sequences are associated with database index values and potential alignment positions are associated with index values.

89. A method as claimed in claim 88 wherein index values and its associated potential alignment positions are discarded if the number of instances of potential alignment positions for that index value exceeds a threshold value.

90. A method for improving a sequence alignment process, including analysing results from one or more sequence alignment processes, and modifying one or more parameters for the sequence alignment process based on the analysis.

91. A method as claimed in claim 90 wherein modification is based on user feedback.

92. A method as claimed in claim 90 wherein modification is based on simulation of an alignment process.

93. A method as claimed in claim 92 wherein a known genetic sequence is used as the basis of simulation.

94. A method as claimed in claim 93 wherein the known genetic sequence is modified by random noise.

95. A method as claimed in claim 33 wherein the known genetic sequence is modified to in a manner representative of errors produces by a sequencing machine.

96. A method as claimed in any one of claims 93 to 95 wherein the known genetic sequence is modified by user prescribed modification.

97. A method as claimed in any one of claims 93 to 95 wherein the known genetic sequence is modified based on the chemistry of the sequence concerned.

98. A method as claimed in any one of claims 90 to 97 wherein the results of the simulated alignment are compared with the results of an actual alignment to determine a confidence value for the alignment method.

99. A method as claimed in claim 98 wherein the confidence level is used for variance calling.

100. An identification system for identifying genetic material including a sequencing unit, a data processing unit, and an output unit, wherein the sequencing unit is configured to read genetic sequences and output a data sequence representing the genetic sequence to the data processing unit, which is configured to analyse a data sequence with respect to a database of known genetic sequences and provide an output from the output unit when sequence matching is of a prescribed level.

b 101. A system as claimed in claim 100 wherein the database is dynamically updated.

102. A system as claimed in claim 101 wherein the database is dynamically updated in a distributed network of devices.

103. A system as claimed in any one of claims 100 to 102 wherein the genetic sequences are hazardous to humans.

104. A system as claimed in any one of claims 100 to 103 wherein an alert signal is generated when hazardous material is detected to a prescribed confidence level.

105. A system as claimed in claim 104 wherein an electronic message is sent to a prescribed group of recipients upon detection of a hazardous material.

106. A system as claimed in any one of claims 100 to 105 operating in accordance with a method as claimed in any one of claims 61 to 99.

107. A sequencing machine configured for monitoring reads as they are obtained, comparing the reads to reference sequences, and indicating contamination if the comparison is within a prescribed level.

108. A sequencing machine as claimed in claim 107 wherein the reference sequences are known contaminants.

109. A sequencing machine as claimed in claim 107 wherein the reference sequences are dependent on operational parameters of the sequencing machine.

110. A sequencing machine as claimed in claim 109 wherein the reference sequences are dependent on the type of sequence being sequenced.

111. A sequencing machine as claimed in claim 109 wherein the reference sequences are dependent on the environment.

112. A sequencing machine as claimed in any one of claims 107 to 111 wherein an alert is generated if the comparison is within a prescribed level.

113. A sequencing machine as claimed in any one of claims 107 to 112 wherein sequencing of a sample is suspended if the comparison is within a prescribed level.

114. A system as claimed in any one of claims 107 to 113 operating in accordance with a method as claimed in any one of claims 61 to 99.

What is claimed is:

1. A computer-implemented method of evaluating the correlation between a set of segments of a sample sequence and one or more reference sequences including the steps of:
a. indexing the segments of the sample sequence to generate indexes in a database;
b. comparing segments of the one or more reference sequences with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met,
wherein the segments of the sample sequence are obtained by passing a plurality of masks over the sample sequence, and the plurality of masks comprises masks which comprise indels.

2. A method as claimed in claim 1 wherein the sets of correlated segments of the sample sequence for which the spacing is within a defined range comprise paired-end reads of nucleotide sequence.

3. A method as claimed in claim 2 wherein the sample sequence is obtained using a DNA sequencer which generates paired-end reads.

4. A method as claimed in claim 1 wherein indexing the sample sequences includes generating an index value for each unique segment of the sample sequences and associating an identifier of the sample sequence and position of the segment with each index value.

5. A method as claimed in claim 1 wherein the plurality of masks comprises masks of a fixed length.

6. A method as claimed in claim 1 wherein the plurality of masks comprises masks which comprise substitutions.

7. A method as claimed in claim 1 wherein the one or more reference sequences are sequentially streamed through the database.

8. A method as claimed in claim 1 wherein multiple reference sequences are streamed through the database in parallel.

9. A method as claimed in claim 1 wherein segments of multiple reference sequences are compared with the database indexes.

10. A method as claimed in claim 1 wherein the sequences are nucleotide sequences.

11. A method as claimed in claim 10 wherein the sequences are genomic sequences.

12. A method as claimed in claim 1 wherein the sequences are amino acid sequences.

13. A method as claimed in claim 1 wherein each correlated segment within the at least one set of correlated segments is unique.

14. A method as claimed in claim 1 wherein the correlation threshold is based on three or more segments of a sample sequence satisfying two or more range conditions between segments.

15. A method as claimed in claim 1 wherein segments of the sample sequences are considered to be correlated with a reference sequence when less than a maximum number of substitutions, insertions, and/or deletions is needed to achieve a match between a read and a segment of the reference sequence.

16. A method as claimed in claim 1 wherein each index value is a numerical representation of a segment of a sequence.

17. A method as claimed in claim 1 wherein the length of each segment is within the range of 14 to 22.

18. A method as claimed in claim 17 wherein the length of each segment is 18.

19. A method as claimed in claim 1 wherein each segment of the reference sequence is the same size as the size of the segments of the sample sequence used to build the index.

20. A method as claimed in claim 1, further comprising, for each correlated position, using one or more alignment algorithms to compare the sample sequence with the reference sequence at the correlated position.

21. A method as claimed in claim 20 wherein the one or more alignment algorithms determine correlation with a reference sequence when there is local correlation between a defined portion of a sample sequence and a reference sequence.

22. A method as claimed in claim 20 wherein at least a second alignment algorithm is used to attempt to align any unaligned sequence with the reference sequence.

23. A computer-implemented method of evaluating the correlation between a set of segments of a sample sequence and one or more reference sequences including the steps of:
a. indexing segments of the one or more reference sequences to generate indexes in a database;
b. comparing segments of the sample sequence with the database indexes to identify segments of the sample sequence that are correlated with a reference sequence;
c. obtaining at least one set of correlated segments of the sample sequence that are correlated with a reference sequence;
d. for each set of correlated segments of the sample sequence, determining the spacing between the correlated segments within the sample sequence; and
e. for each set of correlated segments of a sample sequence, if the spacing is within a defined range indicating that a correlation threshold has been met,
wherein the segments of the one or more reference sequences are obtained by passing a plurality of masks over the one or more reference sequences, and the plurality of masks comprises masks which comprise indels.
